(19) United States
(12) Patent Application Publication
(10) Pub. No.: US 2016/0379792 A1
(43) Pub. Date: Dec. 29, 2016

(54) CATHODOLUMINESCENT DEVICE WITH IMPROVED EFFICIENCY

(71) Applicant: COMMISSARIAT A L'ENERGIE ATOMIQUE ET AUX ENERGIES ALTERNATIVES, Paris (FR)

(72) Inventors: Gilles LE BLEVENNEC, Bernin (FR); Caroline Celle, Firminy (FR)

(73) Assignee: COMMISSARIAT A L'ENERGIE ATOMIQUE ET AUX ENERGIES ALTERNATIVES, Paris (FR)

(21) Appl. No.: 15/192,296

(22) Filed: Jun. 24, 2016

(30) Foreign Application Priority Data
Jun. 25, 2015 (FR) 15 55887

(51) Int. Cl. H01J 29/18; H01J 3/02

(52) U.S. Cl. CPC H01J 29/18; H01J 3/022

(57) ABSTRACT

A cathodoluminescent device, including a luminescent layer having a first side, called the front side, that is intended to receive incident electrons, the luminescent layer being suitable for absorbing incident electrons and for emitting light radiation in response, wherein the front side of the luminescent layer is coated with a layer including electrically conductive nanowires.

### TECHNICAL FIELD

The field of the invention is that of cathodoluminescent devices, i.e. devices including a layer produced from a material suitable for absorbing incident electrons and for emitting light radiation in response.

### PRIOR ART

Cathodoluminescent devices are widely used in the field of lighting, in the field of displays or even in the field of imagers. They include a layer produced from a luminescent material suitable for absorbing incident electrons and for emitting light radiation in response. This luminescent layer is conventionally placed in a vacuum chamber in which an electron source emits a beam of electrons that impact one side, called the front side, of said luminescent layer. The light radiation emitted by the luminescent layer is then extracted from the layer and forms the output optical signal of the cathodoluminescent device.

With the aim of preventing the light generated in the luminescent layer from being back scattered into the interior of the chamber before contributing to the output signal, as this decreases the optical collection efficiency of the luminescent layer, i.e. the ratio of the number of photons collected to form the output signal to the number of photons generated, a thin layer of aluminium is generally deposited on the front side of the luminescent layer. This thin layer must be thick enough to provide the optical-reflection function without however being so thick as to limit the partial absorption of the energy of the incident electrons, as this would decrease the electronic transmission efficiency, i.e. the ratio of the number of electrons transmitted to the luminescent layer and of sufficient energy to provoke the emission of light to the number of incident electrons. The optical collection efficiency and the electronic transmission efficiency both have an influence on the overall efficiency of the cathodoluminescent device, defined here as the ratio of the number of photons generated and participating in the output optical signal to the number of incident electrons.

Document WO 2013/102883 describes an exemplary cathodoluminescent device, here a light bulb, in which a thin aluminium layer covers a ferroelectric luminescent layer and provides a biasing function, a parasitic charge removal function and a function as an optical reflector with respect to photons generated in the luminescent layer. Specifically, apart from the aforementioned optical-reflection function, the aluminium layer may be biased to generate, with the electron source in the interior of the vacuum chamber, an electric field allowing the electrons to be oriented and accelerated in the direction of the luminescent layer. In addition, since the luminescent layer conventionally has a low electrical conductivity, residual negative electrical charges may be present on the front side, thereby creating a decrease in the electrical potential on said side or even an electrostatic repulsion, which decreases the kinetic energy of the incident electrons. The overall efficiency of the cathodoluminescent device may thus be degraded.

### SUMMARY OF THE INVENTION

The objective of the invention is to at least partially remedy the drawbacks of the prior art and more particularly to provide a cathodoluminescent device having an improved overall efficiency. To this end, the subject of the invention is a cathodoluminescent device, including a luminescent layer having a first side, called the front side, that is intended to receive incident electrons, said luminescent layer being suitable for absorbing incident electrons and for emitting light radiation in response, characterized in that the front side of the luminescent layer is coated with a layer including electrically conductive nanowires.

The following are certain preferred but nonlimiting aspects of this cathodoluminescent device:

The nanowire layer may have a nanowire area fraction comprised between 0.2 and 1 and preferably lower than 1.

The nanowire layer may be formed from a perculating network of electrically conductive nanowires and be intended to be electrically connected to a source of electrical potential.

The nanowire layer may have a sheet resistance lower than or equal to 500 Ω/sq and preferably lower than or equal to 100 Ω/sq.

The average length of the nanowires may be larger than the average thickness of the nanowire layer.

The nanowires may have an aspect ratio, defined as the ratio of an average length to an average diameter, higher than or equal to 10 and preferably higher than or equal to 100.

The nanowires may be produced from a metal chosen from gold, silver and copper or from a material chosen from ITO and AZO.

The nanowires may be suitable for emitting light radiation at a first wavelength when they are excited by said incident electrons, and the luminescent layer may be suitable for absorbing light radiation emitted by the nanowires at a first wavelength and for emitting in response light radiation at a second wavelength what is called luminescent wavelength longer than said first wavelength.

The cathodoluminescent device may comprise an electron source suitable for emitting a beam of electrons in the direction of the front side of the luminescent layer.

### BRIEF DESCRIPTION OF THE DRAWINGS

Other aspects, aims, advantages and features of the invention will become more clearly apparent on reading the following detailed description of preferred embodiments thereof, which description is given by way of nonlimiting example and with reference to the appended drawings, in which:

FIG. 1 is a schematic cross-sectional view of an exemplary cathodoluminescent system including a luminescent layer covered with a layer of electrically conductive nanowires; and

FIG. 2 is a top view of an exemplary nanowire layer formed from silver nanowires.

### DETAILED DESCRIPTION OF PARTICULAR EMBODIMENTS

In the figures and in the rest of the description, the same references represent similar or identical elements. In addition, the various elements are not shown to scale in order to make the figures clearer.

The invention relates to a cathodoluminescent device. By cathodoluminescence what is meant is the property of a material of generating light radiation, for example in the UV, the visible and/or the infrared, in response to the absorption of incident electrons. The cathodoluminescent device may be used in various types of optical system, for example cathode tubes, field emission displays, nightvision binoculars or even cathodoluminescent light bulbs.

The invention also relates to electrically conductive nanowires. By “nanowire” what is meant is a three-dimensional structure of elongate shape at least two what are called transverse dimensions of which are about a few nanometres to a few hundred nanometres, for example comprised between 2 nm and 500 nm and preferably between 2 nm and 150 nm, the third what is called longitudinal dimension being larger, preferably at least 2 times larger, even at least 5 times larger, and preferably at least 20 times larger or even at least 100 times larger than the two transverse dimensions. By way of illustration, in certain embodiments, the nanowires have a transverse dimension, or diameter, of about 60 nm and a longitudinal dimension, or length, of about 1 μm, or even of about 10 μm.

The nanowires may have a cross section of circular, oval or even polygonal shape. The longitudinal shape of the nanowires may be cylindrical, conical or even frustoconical. By diameter of a nanowire, what is meant is the average value of the two transverse dimensions along the longitudinal dimension of the nanowire.

The nanowires are produced from an electrically conductive material, for example from a metal preferably chosen from Ag, Cu, Au, Pt, Pd, Ni, Co, Rh, In, Ru, Fe, CuNi and mixtures of two or more thereof, and more preferably chosen from Ag, Au or Cu. The nanowires may be produced from a non-metal, such as for example indium tin oxide (ITO) or aluminium-doped zinc oxide (AZO).

A layer including nanowires is a layer formed from a plurality of nanowires that extend over the surface of a carrier and that define the optical and electrical properties of the layer. The nanowire layer therefore differs from the aforementioned thin aluminium layer in that the material of the nanowires does not extend continuously in the three dimensions of the layer. The aluminium layer is in contrast a layer that may be qualified continuous insofar as the aluminium extends continuously in the three dimensions of the layer. It is possible to define, for a nanowire layer, a nanowire area fraction (AF) as being the product of the projected area of a nanowire and of the number of nanowires per unit area. It will be understood that, for a nanowire area fraction lower than 1, the nanowire layer includes at least one zone in which there are no nanowires in the thickness of the layer.

In the rest of the description, the terms “substantially” and “approximately” are understood to mean “to within 10%”. Moreover, the terms “comprised between . . . and . . . ” and “ranging from . . . to . . . ” are understood to mean inclusive of limits unless otherwise specified.

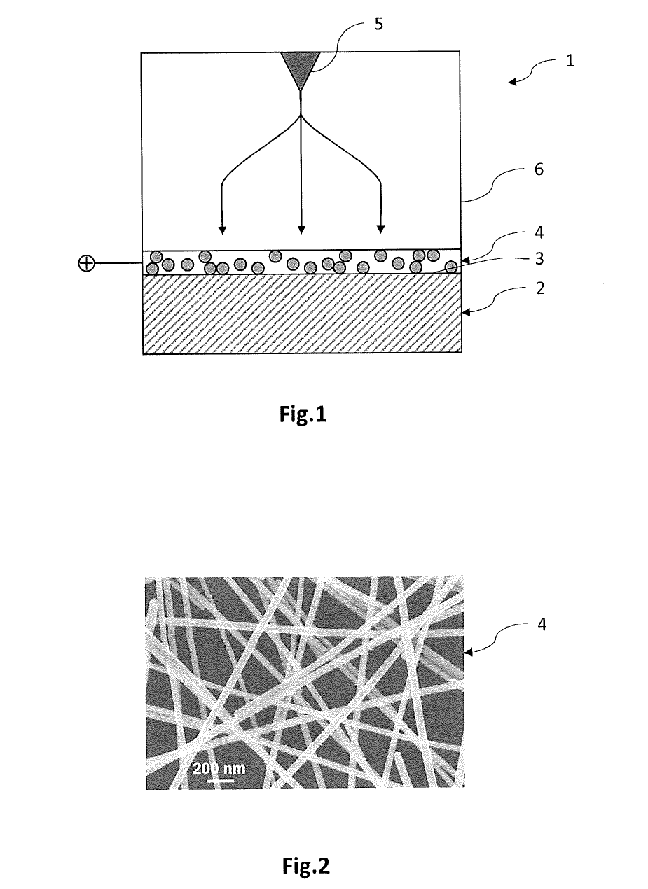

FIG. 1 illustrates an exemplary cathodoluminescent device 1 able to be used in a system such as a cathode tube, a field emission display, a pair of nightvision binoculars or even a cathodoluminescent light bulb.

The cathodoluminescent device 1 comprises a luminescent layer 2 having a first side 3, called the front side, that is intended to receive incident electrons, said luminescent layer 2 being produced from a material able to absorb incident electrons and to emit light radiation in response. The luminescent layer 2 is coated on its front side 3 with a layer 4 formed from electrically conductive nanowires. The stack formed from the nanowire layer 4 and the luminescent layer 3 is placed facing an electron source 5 suitable for emitting a beam of electrons in the direction of this stack. The stack and the source are here both placed in a vacuum chamber 6.

The luminescent layer 2 may be produced from one or more luminescent or phosphorescent materials chosen depending on the desired emission wavelength and the type of application. Thus, by way of illustration, in the case of image intensifiers, the luminescent material may, for example, be a phosphor of standard P43 composition, i.e. Gd₂O₂S:Tb emitting in the green at about 545 nm, or a phosphor of P22 composition formed from a mixture of ZnS:Ag, of (ZnCd)S:Cu and of Y₂O₂S:Eu, also emitting in the green. By way of yet another example, for an application in a cathode ray tube, a terbium- or cerium-doped yttrium-aluminium-garnet (YAG) phosphor may be suitable.

The luminescent layer 2 may be produced on the surface of a carrier (not shown), for example a glass envelope of a cathodoluminescent light bulb or a sheet of bundled optical fibres in the case of a light intensifier. The luminescent layer may be obtained by techniques known to those skilled in the art such as settling, painting, decanting, spraying inter alia. It may have an average thickness of about a few microns to a few hundred microns, for example of about 10 μm.

The cathodoluminescent device furthermore comprises a layer of electrically conductive nanowires that coats the front side of the luminescent layer.

According to a first embodiment, the layer of electrically conductive nanowires is an optically reflective layer that provides an optical-reflection function for reflecting light radiation emitted by the luminescent layer in the direction of the front side.

By optical reflective layer, what is meant is a layer suitable for at least partially reflecting the photons emitted by the luminescent layer. In other words, the reflectance of the nanowire layer is nonzero at the wavelength of the light radiation emitted by the luminescent layer, and more precisely is higher than or equal to 15%, or even higher than or equal to 50% and preferably higher than or equal to 80%. By way of example, for nanowires having an average diameter smaller than the wavelength of the light radiation emitted by the luminescent layer, for example of diameter of about 60 nm for a wavelength of about 500 nm, a nanowire area fraction of about 50% leads to a reflectance of about 50%.

By reflective layer formed from nanowires, what is meant is a layer comprising a plurality of nanowires the material of the nanowires and the area fraction AF of which are chosen to obtain the desired reflectance.

The nanowires are here produced from a metal preferably chosen from Ag, Cu, Au, Pt, Pd, Ni, Co, Rh, In, Ru, Fe, CuNi and mixtures of two or more thereof, and more preferably chosen from Ag, Au or Cu.

It will be understood that the higher the area fraction AF the higher the reflectance of the nanowire layer with respect to the light radiation emitted by the luminescent layer will be and therefore the higher the optical collection efficiency will be.

In addition, the nanowire area fraction AF influences the incident-electron electronic transmission efficiency. Specifically, an area fraction AF equal to 1 amounts to forming a layer the nanowires of which continuously cover the surface of the front side of the luminescent layer. It will be understood that by decreasing the area fraction AF at least one zone is formed in which there are no nanowires in the thickness of the nanowire layer. Thus, the incident electrons that pass through this zone do not encounter nanowires and therefore see their kinetic energy not or not much decreased when they impact the luminescent layer. The electronic transmission efficiency is thus improved in so far as, on the one hand, more electrons are transmitted and, on the other hand, more transmitted electrons have their kinetic energy substantially preserved.

Thus, by way of example, in comparison with a continuous layer made of a metal having an incident electron transmission efficiency of 50%, a nanowire layer made of an identical metal to that of the continuous layer has an electronic transmission efficiency that may to a first approximation be written: 1-0.5×AF. Thus, for an area fraction AF of 0.9 or of 0.2, the electronic transmission efficiency will be 55% or 90%, respectively.

Preferably, the nanowire area fraction is comprised between 0.2 and 1 and advantageously lower than 1 in order thus to increase the electronic transmission efficiency while maintaining a satisfactory optical reflectance. By way of example, as specified above, a nanowire area fraction of about 0.5 leads to an optical reflectance of about 50%.

The operation of an exemplary cathodoluminescent device is now described with reference to FIG. 1.

In the interior of the vacuum chamber 6, the electron source 5 emits a beam of electrons in the direction of the luminescent layer 2 the front side 3 of which is covered with the reflective layer 4 of metal nanowires.

The electron beam impacts the nanowire layer 4 and, depending on the electronic transmission efficiency of the cathodoluminescent device, some of the electrons are transmitted by the nanowire layer 4 and penetrate into the luminescent layer 2. When the nanowire area fraction is lower than 1, the electronic transmission efficiency is increased in so far as, on the one hand, more electrons pass through the nanowire layer and, on the other hand, more electrons are transmitted with enough energy to be capable of provoking the formation of electron-hole pairs.

Some of the energetic electrons introduced into the luminescent layer 2 cause electron-hole pairs to form in the luminescent material, some of which recombine radiatively and emit light radiation at a wavelength that is characteristic of the luminescent material.

Lastly, at least some of the light radiation generated by the luminescent layer 2 forms an output optical signal that may, for example, be extracted on the side of the luminescent layer opposite the front side or collected by optical fibres one end of which is located on this opposite side. The nanowire layer 4 provides a mirror optical function with respect to the light radiation emitted in the direction of the front side, thereby allowing the intensity of the output optical signal to be maximized by preventing photons from being lost by transmission to the vacuum chamber.

It will therefore be understood that the overall efficiency of the cathodoluminescent device depends:

on the electronic transmission efficiency of the nanowire layer;
on the energy efficiency of the luminescent layer, defined as the probability density function of formation of electron-hole pairs from the energetic electrons transmitted to the luminescent layer;
on the luminescence quantum efficiency, defined as the probability density function of the radiative recombination generating the light emission; and
on the optical collection efficiency.

In the aforementioned example of the prior art, the use of a continuous aluminium layer, i.e. a layer the aluminium of which extends continuously in the three dimensions of the reflective layer, leads to a high optical collection efficiency but to the detriment of the electronic transmission efficiency. In addition, since the metal layer is continuous, the incident electrons necessarily lose kinetic energy during transmission through the reflective layer, thereby further decreasing electronic transmission efficiency.

In contrast to the aluminium layer used in the examples of the prior art, the reflective layer of metal nanowires, which layer is located on the front side of the luminescent layer, makes it possible to improve the overall efficiency of the cathodoluminescent device by optimizing both optical collection efficiency and electronic transmission efficiency.

According to a second embodiment, the layer of electrically conductive nanowires is suitable for forming an electrode for removing residual charges and for biasing. To this end, the nanowire layer forms a perculating network of nanowires the electrical conductivity of which may be measured. By perculating network of nanowires, what is meant is that enough nanowires make contact with one another for an electrical current to be able to pass through the layer. Thus, it is possible to apply an electrical potential to the nanowire layer in order, on the one hand, to generate an electric field for orienting and accelerating incident electrons in the direction of the nanowire layer and, on the other hand, to remove residual negative charges present in the luminescent layer.

The nanowire layers are here produced from a metal, preferably chosen from Ag, Cu, Au, Pt, Pd, Ni, Co, Rh, In, Ru, Fe, CuNi and mixtures of two or more thereof, and more preferably chosen from Ag, Au or Cu. The nanowires may be produced from a non-metal such as for example ITO or AZO.

It is advantageous for the sheet resistance of the nanowire layer to be lower than or equal to 500 Ω/sq (also denoted 500 Ω/□) and preferably lower than or equal to 100 Ω/sq or even lower than or equal to 20 Ω/sq. To this end, a layer of nanowires is formed the length of the wires of which is larger than the average thickness of the layer, so that the nanowires extend mainly in the plane of the layer. The average thickness of the layer may be comprised between 1 nm and 1 μm and preferably between 5 nm and 500 nm and be about a few nanowire diameters. By way of example, for nanowires of 60 nm diameter, the average thickness of the reflective layer is about 300 nm. In addition, nanowires are produced the aspect ratio of length L to diameter D of which is higher than or equal to 10 and preferably higher than or equal to 100.

Thus, a layer of nanowires of high aspect ratio that extend longitudinally essentially in the plane of the nanowire layer is formed. Thus contact between the nanowires, propitious to decreasing the sheet resistance of the nanowire layer to a value lower than or equal to 500 Ω/sq and preferably lower than or equal to 100 Ω/sq and preferably lower than or equal to 20 Ω/sq, is maximized.

By way of illustration, a layer of silver nanowires of 65 nm diameter and 10 μm length with an area fraction of about 0.1 or even of about 0.2 has a sheet resistance of 20 Ω/sq.

In operation, the nanowire layer forms a biasing electrode the electrical potential of which is applied using a voltage source. Thus, an electric field is formed between the nanowire layer and the electron source. The electrons are then oriented and accelerated by the electric field thus created.

A nanowire area fraction AF higher than or equal to 0.2 allows a low sheet resistance, for example of about 100 Ω/sq or even of about 20 Ω/sq, to be obtained. In addition, an area fraction AF lower than 1 furthermore allows the electronic transmission efficiency to be optimized according to the principal described above. This makes it possible to improve the overall efficiency of the cathodoluminescent device.

According to one variant of this second embodiment, the nanowire layer furthermore provides the optical-reflection function described above. To this end, the nanowires are produced from a metal, preferably chosen from Ag, Cu, Au, Pt, Pd, Ni, Co, Rh, In, Ru, Fe, CuNi and mixtures of two or more thereof, and more preferably chosen from Ag, Au or Cu.

Preferably, the nanowire area fraction is comprised between 0.2 and 1 and advantageously is lower than 1 in order to increase the electronic transmission efficiency while maintaining a sufficient optical reflectance. An area fraction comprised between 0.2 and 0.5 thus ensures a sufficient reflectance and a high electronic transmission efficiency.

According to a third embodiment, the nanowire layer may be suitable for magnifying the overall efficiency of the cathodoluminescent device by provoking, by photoluminescence, an additional light emission in the interior of the luminescent layer.

To this end, the nanowires are suitable for emitting light radiation at a first wavelength shorter than the luminescent wavelength of the luminescent layer. Thus, the metal nanowires preferably have an average diameter smaller than 200 nm and the electric field between the electron source and the nanowire layer is preferably about a few kilovolts.

Thus, in operation, the incident electrons, while passing through the nanowire layer, may excite plasmonic modes in the nanowires, a resonant mode of which may lead to the emission of light radiation at a wavelength shorter than the luminescent wavelength. Thus, the photons emitted by the nanowires via a plasmonic effect may be absorbed in the luminescent layer, if the energy of the photons emitted by the nanowires is higher than the bandgap of the luminescent material. The luminescent layer then emits light radiation by photoluminescence. Thus an additional light emission mechanism is obtained by photoluminescence, which is added to the main cathodoluminescent light-emission mechanism, thereby further increasing the overall efficiency of the cathodoluminescent device.

nanowires are produced from an electrically conductive material, for example from a metal, preferably chosen from Ag, Cu, Au, Pt, Pd, Ni, Co, Rh, In, Ru, Fe, CuNi and mixtures of two or more thereof, and more preferably chosen from Ag, Au or Cu. The nanowires may be produced from a non-metal, such as for example indium tin oxide (ITO) or aluminium-doped zinc oxide (AZO).

The luminescent layer is produced from a material the luminescent wavelength of which is longer than the plasmonic-effect emission wavelength of the nanowires. It may thus be a question of a material chosen from:

materials able to produce a red emission colour, in particular: Y₂O₃:Eu, YVO₄:Eu, Y₂O₂S:Eu, ZnCdS:Ag,In, ZnCdS:Ag, In+SnO₂, LaInO3:Eu;
materials able to produce a green emission colour, in particular: ZnO:Zn, ZnO:Zn,Si,Ga, (ZnMg)O:Zn, Gd₃Ga₅O₂:Tb, Y₂(AlGa)₅O₂:Tb, Y₃Al₅O₂:Tb, Y₂O₂S:Tb, ZnS:Cu,Al, ZnCdS:Cu,Al, ZnGa₂O₄:Mn, ZnSiO₄:Mn, Gd₂O₂S:Tb, SiGa₂S₄:Eu, Y₃Al₅O₂:Ce;
materials able to produce a blue emission colour, in particular: ZnS:Ag,Cl, ZnS:Ag,Cl,Al, ZnS:Ag, ZnS:Zn, ZnS:Te, ZnGa₂O4 and Y₂SiO₅:Ce;

and mixtures thereof. Of course, those skilled in the art will be able to combine various fluorescent materials and to vary their proportions, with regard to the emission colour desired for the cathodoluminescent device.

By way of example, an electron beam in an electric field of 6 kV between the electron source and the nanowire layer, of 200 electrons per second, makes it possible to excite silver nanowires of 60 nm diameter and of 2 μm in length, which emit light radiation of 350 nm wavelength in response. These photons emitted by the nanowires are transmitted to the luminescent layer and some of them are absorbed by the luminescent material which emits light radiation at its luminescent wavelength of 520 nm in the case of the phosphor of P22 composition.

As a variant of this embodiment, the nanowire layer may also provide the optical reflection function and/or that of the charge-removal and biasing electrode, which functions were described above.

An exemplary process for producing a cathodoluminescent device is now described in the case of a layer of silver nanowires.

Firstly, silver nanowires are produced in solution. To this end, 1.766 g of polyvinyl pyrrolidone (PVP) is added to 2.6 mg of sodium chloride (NaCl) in 40 ml of ethylene glycol (EG). The mixture is stirred at 600 rpm at 120° C. until the PVP and NaCl are completely dissolved. Using a dropping funnel, this mixture is added dropwise to a solution of 40 ml of EG in which 0.68 g of silver nitrate (AgNO₃) has been dissolved. An oil bath is heated to 160° C. and the mixture left to stir at 700 rpm for 80 minutes. Three washes are carried out with methanol while centrifuging at 2000 rpm (rotations per minute) for 20 min, then the nanowires are precipitated in acetone and lastly redispersed in water or methanol.

The nanowire layer is produced by spraying the solution of metal nanowires at 0.5 g/L in methanol onto an oxide-, sulphate- or phosphate-based ceramic luminescent layer using a Sonotek spray coater. The luminescent layer may be made of a material of P43 reference made of Gd₂O₂S:Tb, or of P22 reference formed from a mixture of the materials ZnS:Ag, (ZnCd)S:Cu and Y₂O₂S:Eu.

For long silver nanowires, typically of up to 10 μm length for a diameter of 65 nm, and with a weight per unit area of nanowires of 33 mg/m², a nanowire layer of area fraction of about 0.1 is obtained for a sheet resistance of about 20 Ω/sq. The optical reflectance is about 13% and the electronic transmission about 87%. For shorter silver nanowires, of 2 μm length and 65 nm diameter, and for a weight per unit area ranging from 10 to 50 mg/m², a nanowire layer of area fraction ranging from 0.02 to 0.1 is obtained and the sheet resistance is about 100 Ω/sq. The nanowire area fraction may be adjusted by increasing the weight per unit area during the manufacture of the nanowires, especially by evaporating a predetermined amount of solvent, or even by carrying out a plurality of successive depositions of nanowire layers of given area fraction.

The length and diameter dimensions of the nanowires may be measured by scanning electron microscope (SEM). It is also possible to estimate the area fraction of the nanowires from an image obtained by SEM. The area fraction of the nanowires may also be estimated from the diameter D of the nanowires and from the weight per unit area T using the relationship AF=4/(π.ρ).(T/D), where p is the density of the material of the nanowire. The weight per unit area may be estimated by determining the area covered by the wires for a reference area, from an electron microscope image

The sheet resistance of the nanowire layer may be measured in a conventional way, for example using a Loresta EP four-point resistivity meter. The reflectance of the nanowire layer may be estimated by spectrometry, for example using a Varian Cary 500 spectrophotometer.

1. A cathodoluminescent device, including:
a luminescent layer having a first side, called the front side, that is configured to receive incident electrons, said luminescent layer being suitable for absorbing incident electrons and for emitting light radiation in response,
wherein the front side of the luminescent layer is coated with a layer including electrically conductive nanowires.

2. The cathodoluminescent device according to claim 1, wherein the nanowire layer has a nanowire area fraction comprised between 0.2 and 1 and preferably lower than 1.

3. The cathodoluminescent device according to claim 1, wherein the nanowire layer is formed from a perculating network of electrically conductive nanowires and is intended to be electrically connected to a source of electrical potential.

4. The cathodoluminescent device according to claim 3, wherein the nanowire layer has a sheet resistance lower than or equal to 500 Ω/sq and preferably lower than or equal to 100 Ω/sq.

5. The cathodoluminescent device according to claim 1, wherein the average length of the nanowires is larger than the average thickness of the nanowire layer.

6. The cathodoluminescent device according to claim 1, wherein the nanowires have an aspect ratio, defined as the ratio of an average length to an average diameter, higher than or equal to 10 and preferably higher than or equal to 100.

7. The cathodoluminescent device according to claim 1, wherein the nanowires are produced from a metal chosen from gold, silver and copper or from a material chosen from ITO and AZO.

8. The cathodoluminescent device according to claim 1, wherein the nanowires are suitable for emitting light radiation at a first wavelength when they are excited by said incident electrons, and the luminescent layer is suitable for absorbing light radiation emitted by the nanowires at a first wavelength and for emitting in response light radiation at a second wavelength what is called luminescent wavelength longer than said first wavelength.

9. The cathodoluminescent device according to claim 1, furthermore comprising an electron source suitable for emitting a beam of electrons in the direction of the front side of the luminescent layer.
